(19) United States
(12) Patent Application Publication
(10) Pub. No.: US 2025/0315983 A1
(43) Pub. Date: Oct. 9, 2025

(54) LIGHT TRANSPORT SIMULATION FOR TRANSLUCENT PARTICLES IN CONTENT GENERATION SYSTEMS AND APPLICATIONS

(71) Applicant: Nvidia Corporation, Santa Clara, CA (US)

(72) Inventors: Yujin Zhanglin, Fuzhouu (CN); Xueqing Yang, Shanghai (CN); Nan Lin, Shanghai (CN)

(21) Appl. No.: 18/641,954

(22) Filed: Apr. 22, 2024

(30) Foreign Application Priority Data
Apr. 7, 2024 (WO) PCT/CN2024/086450

(51) Int. Cl. G06T 7/90; G06T 7/70; G06T 11/60

(52) U.S. Cl. CPC G06T 7/90; G06T 7/70; G06T 11/60

(57) ABSTRACT

Approaches presented herein provide for the generation of images involving one or more particle simulations to represent visual features or objects such a smoke or fire. Translucent sprites having similar material properties can be grouped, and a single intersection of a traced ray determined with respect to a boundary of the group. A single call to a hit shader (or other such component) can be performed for the sprite group as a whole. The individual sprites can be reoriented in the hit shader as appropriate, such as with respect to the direction of the traced ray or orientation of a main camera used for the image, but also to account for reflections, refractions, diffractions, or other such secondary effects. Since the sprites have similar material properties, the locations of the intersected sprites of the group can be used to determine and blend color values for the sprites, to be returned as a single color value for the ray with respect to the entire sprite group.

### CROSS-REFERENCE TO RELATED APPLICATIONS

This application claims priority to PCT Application Serial No. PCT/CN2024/086450 filed Apr. 7, 2024, and entitled “LIGHT TRANSPORT SIMULATION FOR TRANSLUCENT PARTICLES IN CONTENT GENERATION SYSTEMS AND APPLICATIONS,” which is hereby incorporated herein in its entirety and for all purposes.

### BACKGROUND

For various content generation operations—such as those used to generate realistic images—there may be various objects or features in the image that can benefit from simulation using a large number of small objects. In at least some instances, these small objects—such as particles of a particle-style simulation—can be represented by two-dimensional (2D) sprites or other such representations. The 2D sprites can be relatively small in size, such that many of them can be used in a scene to render features such as smoke, an explosion, flowing water, or fire. When using a technique such as ray tracing to determine pixel values for an image of the scene to be rendered, however, the orientation of these 2D sprites may not be appropriate for the direction of a given ray, which can result in rays not intersecting with these sprites in the intended way, resulting in lower quality results. Further, if effects such as reflection or refraction are present, the sprites may have unrealistic orientations for a given camera position and/or orientation. Some prior approaches attempt to reorient the sprites as appropriate for a virtual camera location, but these approaches may suffer from asymmetries or inaccurate hit determinations as well. The problem can be exacerbated when the sprites are at least partially translucent such that a given ray should intersect with a number of sprites, and the final color for a given pixel determined based upon values sampled from the intersected sprites.

### BRIEF DESCRIPTION OF THE DRAWINGS

Various embodiments in accordance with the present disclosure will be described with reference to the drawings, in which:

FIGS. 1A-1C illustrate the intersection of a traced ray with translucent sprites in a scene, in accordance with various embodiments;

FIG. 2A-2E illustrate the intersection of a traced ray with translucent sprites using a two-level approach with sprite groupings, in accordance with various embodiments;

FIG. 3 illustrates an example sprite reorientation approach for a reflection, in accordance with various embodiments;

FIG. 4 illustrates an example block diagram illustrating modules in an image generation pipeline, in accordance with various embodiments;

FIG. 5 illustrates an example process for generating an image of a scene including translucent sprites, in accordance with various embodiments;

FIG. 6 illustrates components of a distributed system that can generate image content, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, manufacturing and quality check systems, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, manufacturing systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

Approaches in accordance with various illustrative embodiments provide for the use of ray tracing in rendering images of scenes including visual components—such as may relate to fire, smoke, water, grass, or billboarded objects—that can be represented using particle simulations. A particle simulation can involve the “emission” of several translucent sprites, quads, or other such elements that, when rendered in aggregate, give the appearance of a visual component or feature such as water or smoke that may move or flow between images or video frames. Simulating a significant amount of smoke, for example, can involve emitting a large number of particles, where each of these particles can be at least somewhat translucent. Due in part to the translucent nature, it can be necessary in at least some existing systems to determine a sample value for each particle intersected or “hit” by a given ray. This can involve calling a hit shader for each sprite hit by a traced ray, of which there may be many. In at least one embodiment, a ray or path tracing operation can take advantage of the fact that the translucent particles (e.g., sprites) for a given emitter (or simulated object) will often have identical (or at least substantially similar) material properties. Sprites of a similar material, or corresponding to a single emitter, for example, can be grouped into a sprite group, and a bounding box (or other such boundary or representation) determined around a given sprite group, where all sprites within that group will have similar material properties. A ray can then be traced and a determination made as to whether the ray intersects this sprite group bounding box (and thus may intersect one or more of the individual sprites within that group).

If a hit is detected with respect to a bounding box for a given sprite group, a single hit shader can be called for this sprite group based at least in part on this group hit or intersection. Within the hit shader, the translucent sprites of that group can be reoriented as necessary to be orthogonal to the direction of the ray, which can help to avoid quality issues with misaligned two-dimensional (2D) sprites. A lightweight ray tracing algorithm (e.g., TraceRayInline as discussed in more detail later herein) can be used in the shader to determine the locations of the sprites in that sprite group that are interested by the ray that was determined to intersect the sprite group bounding box. Since all the sprites in the group have essentially the same material properties, the locations of the reoriented translucent sprites that are hit by that ray can be returned from the lightweight algorithm, and the locations can be used with the material properties to determine the color value for the pixel (corresponding to the ray) to be returned from the shader. In this way, the number of expensive calls to a hit shader can be significantly reduced, with one call for an intersected sprite group rather than one call for each intersected sprite, which can drastically improve performance, and the ability to correctly orient and position sprites based on the ray direction can provide high quality rendered image data for the particle simulation. For reflections, the sprites can also be considered to be “located” in a virtual location opposite the reflective surface in order to have the appropriate orientation that is symmetric with the object being reflected.

Variations of this and other such functionality can be used as well within the scope of the various embodiments as would be apparent to one of ordinary skill in the art in light of the teachings and suggestions contained herein.

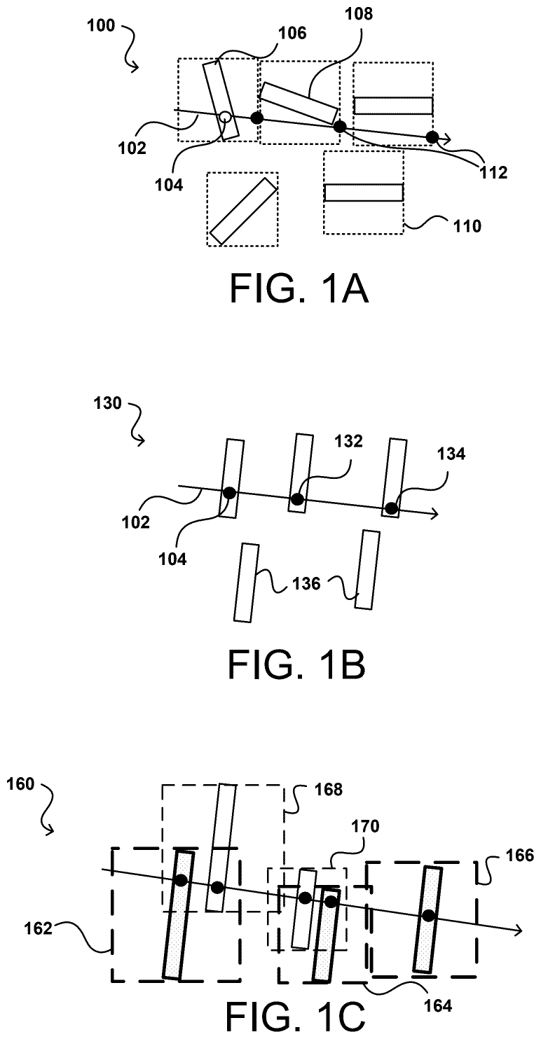

FIG. 1A illustrates an example set of two-dimensional (2D) sprites 100 that can be used to represent a visual object or feature—such as fire or smoke—in an image of a scene or environment to be rendered. A sprite, as used herein, refers to a transparent, view-oriented quad or other such element or object useful for representing a relatively small particle in a scene. It should be understood that there may be many additional sprites used, and that cross-sections of 2D sprites oriented orthogonal to the plane of the page are used for simplicity of explanation, but that many other orientations are possible in a scene. In this example, there are five 2D sprites that are emitted to function as particles in a particle simulation, where each particle can move at least somewhat independently, but the movement of nearby particles may be influenced by similar forces, as may be due to wind or pressure, among other such factors. For an example particle simulation, the individual particles may be represented by 2D objects such as sprites or quads, which can require significantly less storage and processing than would be required for 3D models or objects. While this reduction in resource capacity has its advantages, the use of 2D images (or other objects such as meshes or models) to represent 3D particles has the potential downside that the sprites may be in random orientations with respect to a ray to be traced.

For example, in FIG. 1A, a ray 102 may be traced through the scene that is determined to intersect at a hit point 104 of a single sprite 106. Due to the random orientations of the sprites, however, the probability of a ray hitting a given sprite depends at least in part upon the relative orientation of the particle. As an example, the distances between the center points of a first sprite 106 and a second sprite 108 and the traced ray 102 are similar, but due to their different orientations, only one of the sprites 106 is intersected by the ray while the other sprite 108 is not. Even if the sprites were all arranged to have the same orientation, different rays will come from different directions, as may be due not only to the angular spread of a virtual camera but also due to factors such as reflections, refractions, diffractions, and other secondary effects. Thus, there is no way to orient the rays so that they are all fully orthogonal to all traced rays without the need to make adjustments for at least some of the rays. In some systems, bounding boxes 110 can be positioned about each sprite, where a bounding box may be centered at the center point of the sprite and have a width and height appropriate to bound the sprite in any orientation about that center point. Intersection points 112 between the traced ray 102 and the bounding boxes 110 can then be determined, to identify which sprites should be considered for a given ray but may not otherwise provide a hit point for the ray due to the orientation of those sprites.

As illustrated in FIG. 1B, at least some of the sprites 130 can be rearranged corresponding to a given ray 102 so that they are orthogonal to the direction of the ray. The sprites to be reoriented can include, for example, those sprites whose bounding boxes were intercepted by the ray in FIG. 1A. In some embodiments, all sprites may be reoriented, including sprites 136 who did not have a bounding box intersected by the ray, but such reorientation may not be optimal in all situations due to the additional overhead incurred. In this example, hit points for bounding boxes are identified first and then sprites reoriented, although in other approaches sprites could be reoriented first and then a ray traced to perform intersection testing.

After hit testing and reorientation, the appropriate sampling points 104, 132, 134 can be determined for each corresponding sprite, which can help to ensure high visual quality by providing for accurate sampling of an intersected ray at the correct location on individual sprites. As mentioned, these example sprites are translucent, such that a ray does not stop when it intersects a sprite but passes through the sprite and may intersect with one or more other sprites. As illustrated, the traced ray now intersects three sprites due in part to the reorientation, as well as the translucent nature of the sprites. As illustrated, the reorienting of the sprites helps to ensure the intersection of the ray 102 with the appropriate sprites, and provides for an accurate sample points 104, 132, 134 for each intersected sprite.

As mentioned, however, such an approach can result in a large number of hit points, which in prior approaches would require a call to a hit shader for each individual hit. As illustrated in the view 160 of FIG. 1C, this might quickly result in a large number of calls to a hit shader for larger sprites, larger numbers of sprites in a group, or more dense groupings of sprites, among other such selections. In the example of FIG. 1C, there are two types of sprites (represented by white and patterned sprites, respectively) with different material properties. This may correspond to some particles representing flames of a fire and other particles representing the smoke produced by the fire. Because all of these sprites are translucent, a hit shader would need to be called for each of the five hit points for the ray. For each of these calls, the data for the sprite in the respective regions 162, 164, 166, 168, 170 would need to be transmitted to the hit shader as well. As mentioned, such calls can be relatively computationally expensive and/or resource intensive, and can introduce significant additional latency into the shading and/or rendering operations.

In this example, however, there only two types of sprites, where each type has similar material properties. As illustrated, the sprites in sprite regions 162, 164, and 166 all correspond to a first set of material properties, and the sprites in sprite regions 168 and 170 all correspond to a second set of material properties. Approaches in accordance with at least one embodiment can take advantage of the occurrence of these similar material properties to reduce the number of expensive calls to a hit shader, such as to make only one call for each group of sprites having the same material properties rather than for all sprites with a hit point for a given ray.

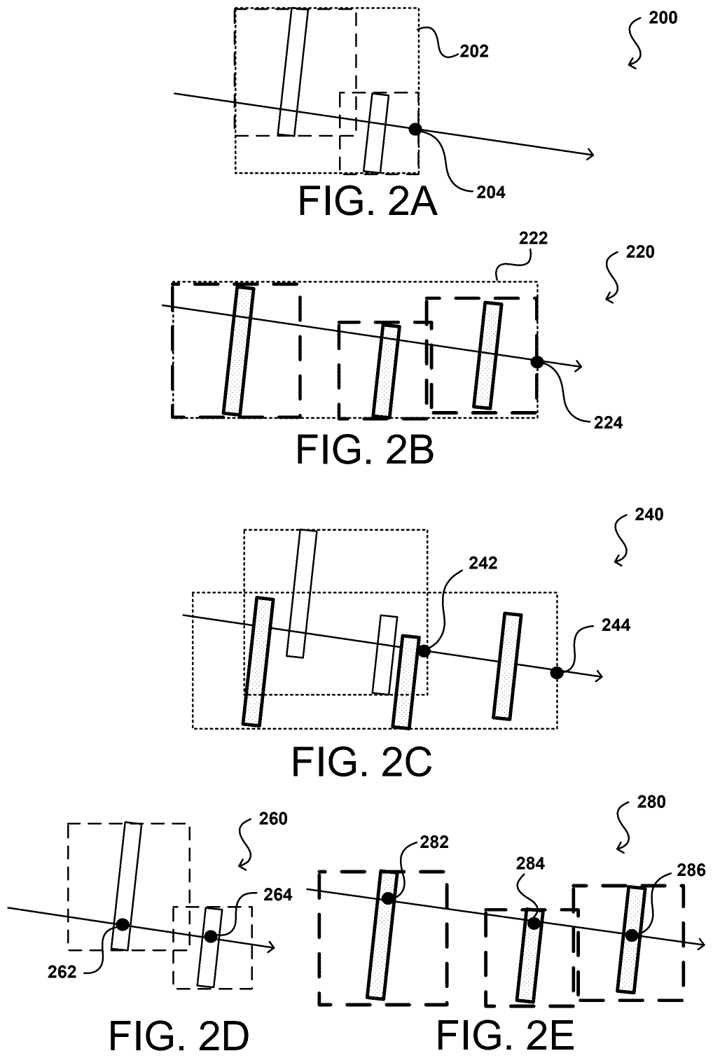

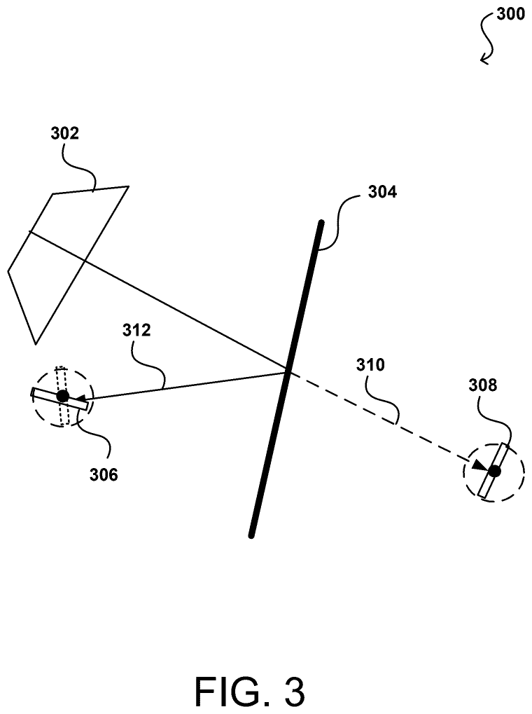

As an example, FIGS. 2A and 2B illustrate the sprites from FIG. 1C, but broken out by material group or “sprite group,” where a sprite group includes at least those sprites that were intersected by a traced ray that have the same material properties. For example, the sprites 200 of FIG. 2A may be used to represent smoke particles and the sprites 220 of FIG. 2B may be used to represent fire particles. In FIG. 2A, a bounding box 202 or other boundary can be determined that bounds the regions of the sprites of this given sprite group. The bounding box for each sprite includes a three-dimensional region of a scene that could include the sprite in any orientation about its center point, centroid, or other such location about which orientation may occur. The bounding box 202 for this sprite group may then be the smallest boundary or a given shape that includes all individual bounding boxes for the individual sprites. While larger boundaries may be used, it can be beneficial to limit the size of the group bounding box in at least some embodiments to avoid reporting a hit on the sprite group when none of the individual sprites in the group might be hit by a given ray. In the example of FIG. 2A, a single call to the hit shader can be made for the sprite group, including the two sprites included in that group. A single hit point 204 can be determined for the entire group with respect to a traced ray. In this example, the hit point is determined using the backside of the bounding box. This hit point on the group boundary can indicate that the ray passes through this sprite group and thus further shading or sampling operations should be performed for this group. If the ray does not intersect the boundary of that sprite group then no additional shading or sampling operation needs to be performed for any of the sprites in the sprite group with respect to that ray. Similarly, in FIG. 2B it can be seen that the boundary 222 around the second sprite group results in a single hit point 224 which can trigger a single call to a hit shader for the sprites in this second sprite group. As illustrated for the sprites 240 in FIG. 2C, such an approach results in only two hit points 242, 244, and two calls to a hit shader, rather than the five hit points and calls in FIG. 1C. It should be understood that for actual simulations a given ray may pass through tens or even hundreds of translucent particles, such that the reduction to a small number of calls for sprites of similar material properties can result in a significant reduction in resource capacity and processing requirements.

Once a hit shader is called for a given sprite group, the hit point determination and sampling for sprites within that group can be determined within the shader, without the need for an additional shader call. As an example, consider the example of sprites 260 of a first shader group as illustrated in FIG. 2D. In this example, all sprites have the same material properties, and the sprite as a whole may have the same material properties across the entirety of a given sprite. Given this, the location at which each sprite is intersected along the ray is the only significant difference for each hit point 262, 264 of this sprite group. A relatively inexpensive call (e.g., TraceRayInline) can be made within the hit shader to determine the locations of the hit points 262, 264 along the ray. The value(s) returned for each hit point will otherwise be the same, due to having the same material properties. The shader can thus use the material properties at each of the hit locations to determine the final value to use for this pixel, based on this pixel group, by blending, combining, or otherwise using the values at these respective locations. Similarly, for the sprite group 280 illustrated in FIG. 2E, the sprites will all have the same material properties so these property values can be used, along with the positions of the hit points 282, 284, 286 along the ray, to determine the value(s) to return for the given pixel group. The final pixel color for the pixel location corresponding to the traced ray can then be determined based in part on a blending of the color values returned from the two pixel groups.

In at least some instances, the sprites in a given sprite group may be similar and have similar material properties, but those properties may vary across a given sprite. For example, a sprite may have asymmetric variations across the sprite. For such situations, the orientation of the sprite may be important not only so that it is orthogonal to a traced ray, but also that out of two possible orientations that are orthogonal to a ray, the correct orientation is selected. If not, the result may be unnatural as having a sprite appear backwards or flipped with respect to an expected orientation. This may be of particular importance for situations such as reflections, refractions, or diffractions. In the example scene 300 illustrated in FIG. 3, there is a mirror 304 positioned with respect to a sprite 306 and a virtual camera 302 used to determine a point of view from which to render an image of the scene. A ray traced with respect to the virtual camera can intersect both the reflective mirror 304 and the sprite 306, which can result in a reflection of the sprite in the mirror impacting the shading of a pixel location corresponding to that ray. When considering how a reflection appears, however, the reflection should appear as if the sprite were on the other side of the mirror, and should have an orientation that is appropriate for that situation. A virtual sprite 308 can thus be considered that is in this apparent location on the other side of the mirror, with a virtual ray 310 that is a mirrored ray with respect to the ray 312 (or portion of the ray) between the mirror 304 and the sprite 306. The orientation of the virtual sprite 308 with respect to the mirrored virtual ray 310 will in at least some situations need to be different than the orientation of the sprite 306 with respect to the traced ray 312. The orientation of the virtual sprite 308 can then be set based on the virtual ray 310, with an orientation that is appropriate for the reflection and does not result in an improper mirroring or flipping of the virtual sprite 308 that appears unnatural in the resulting rendered image. In at least one embodiment, the reorientation of individual sprites can also be performed inside the hit shader, without another call to a separate shader or other component. In at least one embodiment, the reorientation is performed before the hit points for individual sprites of a sprite group are determined within the hit shader. While the orientation of the virtual sprite will be orthogonal to the virtual ray, it can also be considered to be oriented in a tangent plane parallel to a plane of the camera used for the view of the scene. In at least one embodiment, reorientation may not be performed in order to obtain a maximum performance boost, particularly where the precise orientation of the sprites does not have a significant impact on the final appearance of the rendered image when displayed.

In at least one embodiment, sprite reorientation can be performed by mirroring a reflected sprite center to a virtual space. The tangent basis of the virtual sprite can be calculated, and the tangent basis can then be mirror reflected back to “real” space for the scene. In at least one embodiment, the tangent plane of a virtual sprite can be reoriented to be parallel to a primary plane of a main camera for the scene. In at least one embodiment, a mirror reflection matrix can be given by:

$${T}_{sym} = {T}_{sym}^{- 1} = [ \begin{matrix}1 - 2 {n}_{x}^{2} & - 2 {n}_{y} {n}_{x} & - 2 {n}_{z} {n}_{x} & 0 \\ - 2 {n}_{x} {n}_{y} & 1 - 2 {n}_{y}^{2} & - 2 {n}_{z} {n}_{y} & 0 \\ - 2 {n}_{x} {n}_{z} & - 2 {n}_{y} {n}_{z} & 1 - 2 {n}_{z}^{2} & 0 \\ 2 {n}_{x} ( \vec{P} \cdot \vec{n} ) & 2 {n}_{y} ( \vec{P} \cdot \vec{n} ) & 2 {n}_{z} ( \vec{P} \cdot \vec{n} ) & 1\end{matrix} ]$$

where P, \vec{n} determines the reflective plane.

As mentioned, such an approach can be used with various other types of particle simulations or representations as well. For example, a particle simulator might use ribbons in place of sprites or quads to represent individual particles. A ribbon will often provide a trail effect, and may be generated using a set of triangular meshes. Similarly, triangular meshes (or other geometric meshes) can also be used, which can be handled with relative ease in a ray tracing pipeline that is designed to handle mesh representations.

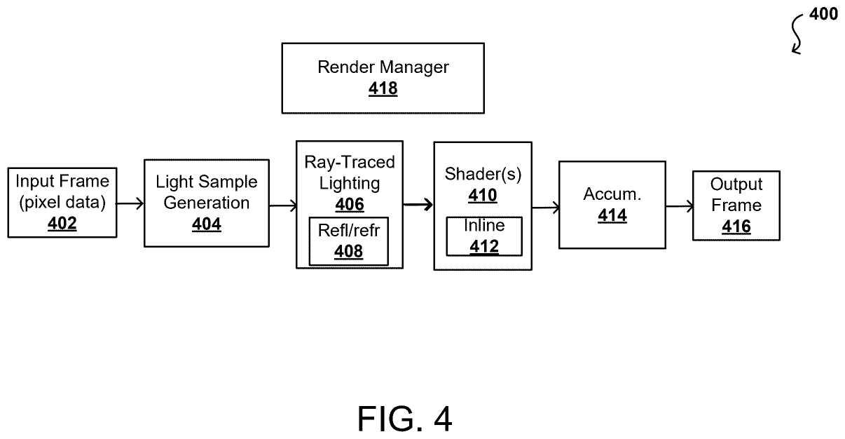

In at least one embodiment, approaches to pixel value determinations in a ray tracing or other such process may be performed as part of an image generation process or system. FIG. 4 illustrates components of an example rendering (or content generation) pipeline 400 that can be used with such a system or process. Such a pipeline can be used to generate or synthesize one or more images, such as video frames in a sequence. In this example, pixel data 402 for a current frame to be rendered (as may include G-buffer data for primary surfaces) can be received, as may include pixel data for various objects to be rendered in a scene from a point of view defined by a virtual camera. The pixel data can be provided as input to a light sample generation component 404 to perform light sampling. The pixel data and light sampling data can be passed to a ray-traced lighting component 406 to perform ray-traced lighting. In this example, the ray-traced lighting component includes a reflections and refractions component 408 to determine secondary lighting effects, as may be due to reflections, refractions, diffractions, or other such aspects of a scene to be rendered. Such secondary effects can impact how rays are traced through a scene as discussed elsewhere herein. The results of the ray-tracing can be provided to one or more shaders 410 (which may be implemented in hardware and/or software). A shader 410 can set the pixel colors for the various pixels of the frame based at least in part upon the determined lighting information (along with other information such as color, texture, and so on). The results can be accumulated by an accumulation module 414 or component for generating an output frame 416 of a desired size, resolution, or format.

As mentioned, a shader 410 can be called by a ray-traced lighting component 406 in at least one embodiment when a ray intersection is detected for an object that is to impact how a given pixel appears in an image or video frame to be rendered. This may include an intersection with a sprite or a sprite group as discussed herein, and if one or more of these sprites are translucent then there may be multiple intersections to be identified. When using sprite groups, a single call can be made from the ray-traced lighting component 406 to a shader 410 upon detecting a hit with a boundary of a given sprite group with similar material properties. The called shader 410 can include functionality, as may correspond to a ray tracing inline function 412, process, or module, which can then determine the intersection points of the sprites within a given group with the traced ray, and can return these intersection points. The shader 410 can then use these intersection points with the material properties of this sprite group to determine how to determine and blend the color values for the individually intersected sprites of the group to come up with an output color value for an associated pixel location that is to be used to determine a final color value for that pixel location.

In at least one embodiment, operations of the pipeline 400 can be performed under direction of a render manager 418 or other such system or process. The render manager can perform tasks such as to direct a ray-traced lighting component 406 to perform ray tracing to obtain samples at determined locations, and perform hit testing. The render manager can determine when to use sprite groups (or other such groupings of similar objects or elements) in a rendering process. The render manager 418 can work with one or more shaders 410 during shader passes to perform shading and blending tasks to determine final pixel values for the various pixel locations of an image to be rendered.

In at least one embodiment, such a pipeline may generate images or video frames in a sequence, where at least some amount of temporal information is retained between frames. Various types of information may thus be at least temporarily stored to one or more buffers between frames, such as may involve at least one graphics buffer, as may include or work together with a color buffer, a motion vector buffer, and/or a depth buffer, among other such options. In at least one embodiment, a pre-processor, such as may involve one or more processes running on one or more processors on one or more computing devices, can receive as input color information for a current frame as produced by a rendering engine or application, as well as output of a warper, such as a warping function or application executing one or more processors of one or more devices. In at least one embodiment, this warper receives as input motion vector information for a current frame as stored in a motion vector buffer, as well as depth information for a current frame, as stored to depth buffer. In at least one embodiment, a warper may receive this data directly from an application or renderer and may not utilize dedicated buffers. A temporal process can also provide, as input to a warper, high resolution color data from a previous image in a sequence, as stored to a history buffer. Information for each final output image can also be stored to a history buffer for use in generating a subsequent image or frame in a sequence. A warper can utilize this motion vector and depth data to warp pixel data or color data for specific features of a prior image to corresponding pixel locations in a current image frame, effectively using these motion vectors to map corresponding pixel locations of features in these two images so color values for similar features can be compared and blended. A pre-processor can perform any relevant processing on current color data from a color buffer or warped prior color data from warper. The data, after any pre-processing, can be provided as input to a neural network, such as a deep learning (DL)-based generator, which can analyze this data to determine pixel specific weightings for each pixel location in an image to be generated. The generated data can be processed by a post-processor, which may include one or more processes executing on one or more processors of one or more computing devices, which can output a final high resolution color image. In at least one embodiment, this post-processor can also output information to be stored to high resolution color and historical buffer for use in generating a subsequent image in a current sequence.

In at least one embodiment, generation of a frame using such an approach can involve an application providing to a reconstruction algorithm a low resolution jittered input image and associated jitter values, low resolution backward motion vectors per individual input image pixels, and other quantities, such as exposure values and a depth buffer. These low resolution input (backward) motion vectors can be used to warp a previous frame output image to align with geometry in a current time step. A low resolution current frame image (after any denoising and detail enhancement as discussed herein) can be upsampled to a resolution of an output image using an upsampling algorithm. A neural network can be used to infer a weighting value w for each output pixel (at an output resolution). In at least one embodiment, a high resolution output image for a current frame can be created as:

$$output = w * ( upsampled current frame input image ) + ( 1 - w ) * ( warped previous output image )$$

In this type of temporal image reconstruction algorithm, a significant factor in resulting image quality (IQ) can be due to weighting factor w above. In at least one embodiment, w should adapt to various criteria, including at least that where a region in an output image is dis-occluded due to motion of objects in a rendered scene, this weighting factor should favor a current input image, or weight color values more heavily from a current image, such as where w=1.0. Where a region in an output image is visible (and shaded similarly) in a previous frame, an optimal weighting factor can result in a suitable blending between these previous output and current input images. In at least one embodiment, this blending can favor history data more, such as where a value of w approaches zero, as more frames have had this region visible.

A network can base this predicted weighting, at least in part, upon a current frame input image and a warped previous frame output image. In at least one embodiment, wherever an upsampled current image has significantly different values from a warped previous frame output image, and thus would appear very different when displayed, a neural network can predict a high valued weighting factor w, giving more importance to an upsampled current frame input image. When a current image has similar values to a warped previous frame output image, and thus would appear very similar when displayed, a neural network can predict a low valued weighting factor w, giving more importance to a warped previous frame output image.

In at least one embodiment, there may be one particle emitter for each particle group (although a single emitter can be reused for different particle groups in at least some systems). Each emitter can emit particles—such as translucent sprites—having the same or sufficiently similar material properties, or other properties that can be used to determine color values for a given lighting or shading situation, etc. In an example rendering pipeline, once a presence of one of these emitters is detected, an intersection of a boundary (or other representation) of the sprite group for the emitter can be determined, and the individual sprites of the group can be traced within the same called hit shader without need to call additional hit shaders. The hit shader can also be configured or trained, such as where a model is used to infer proper orientation, to perform reorientation for individual sprites as needed so the sprites are properly oriented not only with respect to the traced ray, but also with respect to the orientation of a main camera for the scene, given any reflection, refraction, diffraction, or other such effect. Reorientation can be performed for billboarding or other such processes within a hit shader or intersection shader along with hit tracing, where a billboarding process can be used to represent distant objects, such as objects that may be far off in the distance of an outdoor scene from the perspective of the viewer, virtual camera, or viewport.

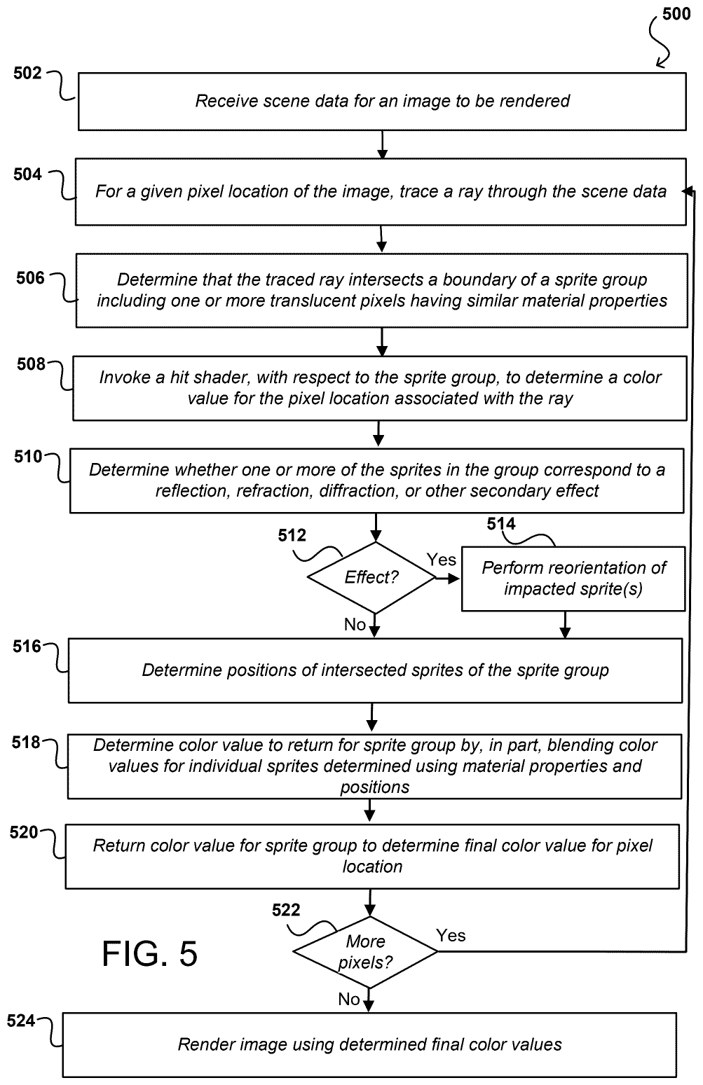

FIG. 5 illustrates an example process 500 to generate an image in accordance with at least one embodiment. It should be understood that for this and other processes presented herein that there may be additional, fewer, or alternative steps performed or similar or alternative orders, or at least partially in parallel, within the scope of the various embodiments unless otherwise specifically stated. Further, although this example will be discussed with respect to translucent sprites, there can be other types of objects or features—such as ribbons or meshes—for which groupings of objects with similar material properties can be used in an image generation process as well within the scope of various embodiments. In this example process 500, scene data is received 502 for an image to be rendered. In many instances, this image will correspond to a video frame of a sequence of video frames, and will be a two-dimensional image of a three-dimensional scene, although various other types of image content can be rendered as well within the scope of the various embodiments. For the image to be rendered, an attempt can be made to determine an appropriate color value (or other pixel value) for each pixel location (or other such location or region) of the image. For a given pixel location in a process that uses ray tracing, a ray can be traced 504 through the scene data to identify one or more objects, surfaces, or other such features that are intersected by the ray and are of a type that should impact a color value determination for the corresponding pixel location. If the scene data includes at least one set of translucent sprites (or other such objects) emitted by an emitter for a particle simulation, for example, the set of sprites can be grouped into a sprite group having a group boundary. It can be determined 506 that the traced ray intersects the boundary of this sprite group. In response, a hit shader (or similar component or process) can be invoked 508 with respect to the sprite group as a whole, to determine a color value for the pixel associated with the ray. As mentioned, a single call to a hit shader can be performed with respect to all sprites of the sprite group, rather than calls for each individual sprite.

A determination can be made 510 as to whether any of the sprites in the group correspond to a reflection, refraction, diffraction, or other such secondary effect, where the use of a mirrored or virtual representation may be appropriate. If such an effect is determined 512 for one or more sprites, then the impacted sprite(s) can have a reorientation performed 514 as appropriate. The proper orientation can be a factor of the direction of the traced ray—such that the orientation is orthogonal to the ray or otherwise in a tangent plane with respect to the main camera for the image, and is in an orientation that is appropriate for the location of the main camera based on the type of secondary effect, such as where mirroring may be appropriate for a reflection as discussed herein. Reorientation of one or more sprites can be performed to ensure not only that the orientation is appropriate to determine a hit for a given traced ray, but also that the appearance of the sprite in the image based is natural for the situation and/or secondary effect if present.

Since the sprites of a sprite group have the same, or substantially similar, material properties, the hit shader can treat the sprites as separate instances of the same sprite but at different positions. The hit shader can determine 516 the positions of the intersected sprite(s) of the sprite group. The hit shader can determine 518 a color value to return for the sprite group by, at least in part, blending color values for the individual sprites using the similar material properties and the respective position(s). A single color value can then be returned 520 for the sprite group that is to be used to determine the final color value for the given pixel location, as there may be other objects with different material properties that are also impacted by the ray and may either be translucent, or may be visible through one or more of the intersected translucent sprites. If it is determined 522 that there are more pixel locations for which color values are to be determined, then the process 500 can continue for the next pixel location (or locations, if done at least partially in parallel). Once the color values have been determined for all pixel locations of the image to be rendered, the image can be rendered 524 using those determined final color values. If this is one image of a sequence, then the process can be repeated for the next image, video frame, or other instance of image data or visual content.

In at least one embodiment, an inline process of a hit shader to perform operations such as hit testing and reorientation can use a process similar to that defined by the following example pseudocode:

```
//emitter loop in ray tracer
While (not miss)
  TraceRay(emitters)
//sprite loop in hit shader
While (not miss)
  TraceRayInline(emitter.sprites)
  ReorientAndIntersectSprite(sprite)
```

As discussed, such a process can perform hit detection in a ray tracing engine with respect to an emitter or sprite group, then within the called shader a process can be performed to reorient the sprites as needed and determine appropriate intersections. Such a two-level ray tracing approach can significantly reduce the number of expensive hit shader calls when calling a hit shader for each sprite intersected by each traced ray for an image, which can significantly reduce aspects such as scheduling overhead when generating image or visual content. Such an approach can also flexibly select an approach to manage order dependency in the second-level tracing. In at least one embodiment, a process can use the inline functionality within a shader to fine out ray sprite intersections for large numbers of sprites, but use software traversal for small numbers of sprites. When the blending mode is order dependent, returning-order can be imposed on the ray tracing call, with the intersections being process out-of-order, or “any hit” style, in other situations. Approaches in accordance with various embodiments support adjusting the orientation of individual sprites based in part on the virtual space sprites, which improves the visual quality of the rendered image with respect to only rotating the sprite based on the position of a virtual camera, which may otherwise result in a reflection to be asymmetric to the sprite in world space.

In at least one embodiment, a hit shader can be invoked any time at least one ray intersection is not opaque. A hit shader can declare a payload parameter and at least one attribute parameter. Hit shaders can perform various tasks in different situations including, and in addition, to those otherwise discussed herein, such as to read and modify a ray payload, read intersection attributes, determine when to end an intersection search, or determine when to ignore a hit, among other such options. These can be performed in addition to any reorientation or hit determination operations discussed herein.

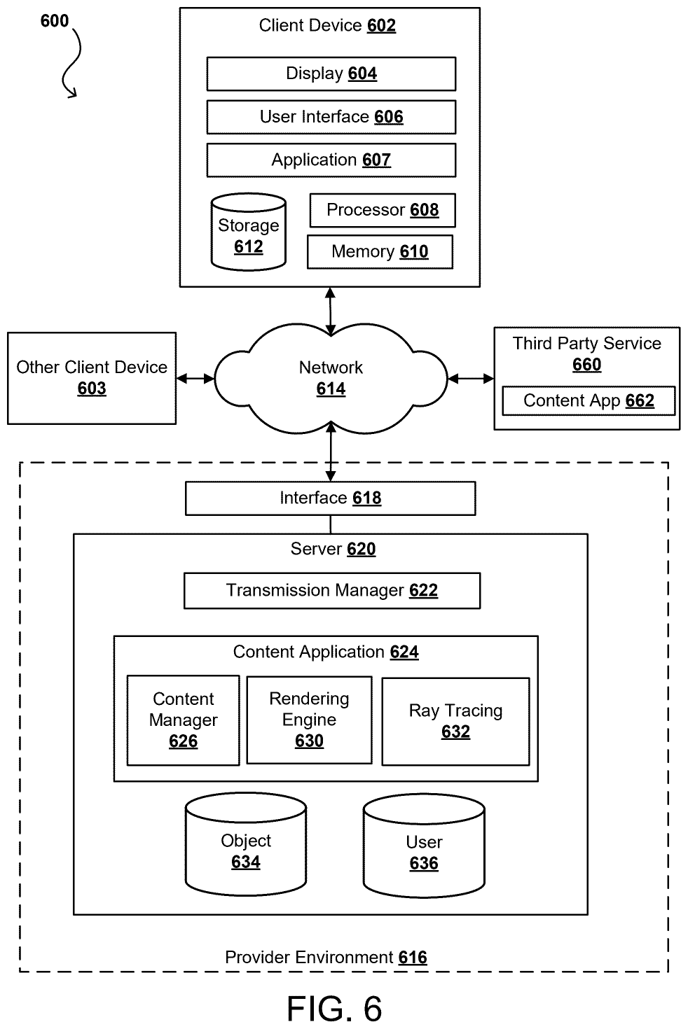

FIG. 6 illustrates an example system environment that includes a synthetic content generation system, in accordance with various embodiments. As an example, FIG. 6 illustrates an example networked system 600 that can be used to provide, generate, modify, encode, process, and/or transmit image data or other such content. The example networked system 600 may include a client device 602, other client device 603, a network 614, a third party service 660, and a provider environment 616 that includes a rendering engine 630 and ray tracing module 632.

The client device 602 may generate or receive data for a session using components of an application 607 executing on client device 602 and data stored locally on that client device 602. As an example, a user may utilize a client device 602 to generate synthetic images using the application 607, and/or to perform machine learning-implemented processing (e.g., detection, classification, tracking, clustering, etc.) using the application 607 (or a different application) using training data including such synthetic images. Although only one client device 602 is illustrated in detail, the networked system 600 may include one or more other client devices 603 that can communicate with the provider environment 616 through network 614. A client device 602 may be any appropriate computing device capable of enabling a user to generate synthetic images as discussed herein, such as may include a desktop computer, notebook computer, computer workstation, gaming console, set-top box, streaming device, smartphone, tablet computer, VR headset, AR goggles, wearable computer, or a smart television. In at least one embodiment, a user can generate synthetic content using a user interface (UI) 606 running on a client device 602, although at least some functionality may also operate on a remote device, networked device, or through a cloud computing platform. In at least one embodiment, a user can provide input to the UI 606, such as through a touch-sensitive display 604 or by moving a mouse cursor displayed on a display screen. In one embodiment, a user may be able to provide inputs such as images, texts, instructions, characteristics of environmental conditions, characteristics of defects, labels, annotations, training dataset, supervising datasets to an application 607. The application 607 may be provided by the provider environment 616 for the user to download on the client device 602. In at least one embodiment, a client device can include at least one processor 608 (e.g., a CPU or GPU) and a memory 610 to execute application 607 and/or perform tasks on behalf of application 607. In at least one embodiment, synthetic images generated through the application 607 can be stored locally to local storage 612.

In one embodiment, each client device 602 can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment. In one or more embodiments, the requests may be received as input text and processed by a language model, such as a large language model (LLM). In one or more embodiments, the requests may be received as input text with one or more images for processing by a vison-language model (VLM).

The network 614 may represent the communication pathways among the client device 602, the provider environment 616, other client device 603, and the third party service 660. Through the network 614, the client device 602 may send input information associated with synthetic defect generation over network 614. The information may be received by a remote computing system, as may be part of a resource provider environment 616. In one embodiment, the network 614 is the Internet. The network 614 can include any appropriate network, including an intranet, Internet, a cellular network, a local area network (LAN), or any other such network or combination, and communication over a network can be enabled via wired and/or wireless connections. The network 614 can also utilize dedicated or private communication links that are not necessarily part of the Internet. In one embodiment, the network 614 uses standard communications technologies and/or protocols. Thus, the network 614 can include links using technologies such as Ethernet, Wi-Fi, integrated services digital network (ISDN), digital subscriber lines (DSL), asynchronous transfer mode (ATM), etc. Similarly, the networking protocols used on the network 614 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. In one embodiment, at least some of the links use mobile networking technologies, such as long term evolution (LTE). The data exchanged over the network 614 can be represented using technologies or formats including the hypertext markup language (XML), the wireless access protocol (WAP), the short message service (SMS) etc. In addition, all or some of the links can be encrypted using conventional encryption technologies such as the secure sockets layer (SSL), secure HTTP or virtual private networks (VPNs). In another embodiment, the client device 602 can use custom and/or dedicated data communications technologies instead of, or in addition to, the ones described above.

The provider environment 616 may include any appropriate components for receiving requests and returning information or performing actions in response to those requests. In the embodiment illustrated in FIG. 6, the provider environment 616 may include an interface 618, and a server 620 that include various components for performing tasks associated with generating synthetic images. In at least one embodiment, the provider environment 616 might include Web servers and/or application servers for receiving and processing requests, then returning data or other content or information in response to a request.

The interface 618 may receive communications to the server 620. In at least one embodiment, interface layer 618 can include application programming interfaces (APIs) or other exposed interfaces enabling a user to submit requests to the server 620. In at least one embodiment, the interface 618 can include other components as well, such as at least one Web server, routing components, or load balancers. In at least one embodiment, components of an interface layer 618 can determine a type of request or communication, and can direct a request to an appropriate system or service such as the rendering engine 630 and/or ray tracing module 632.

The server 620 may include a transmission manager 622, a content application 624, an object storage 634, and a user storage 636. The server 620 may receive requests and data from the client device 602, perform tasks associated with the requests, and send results or other data to the client device 602. In at least one embodiment, a content application 624 executing on the server 620 (e.g., a cloud server or edge server) may initiate a session associated with the client device 602, as may use a session manager and user data stored in a user database 636, and can cause content such as one or more object representations—such as images—from an object repository 634 to be selected by a content manager 626 for processing. At least a portion of the generated content, such as image content generated from the rendering engine 630 and/or ray tracing module 632, may be transmitted to the client device 602 using an appropriate transmission manager 622 to send by download, streaming, or another such transmission channel. In some embodiments, a rendering engine 630 and/or ray tracing module 632 might run on the same server 620 (or a different server) that is trained using the synthetic images, and results of any inferencing or artificial intelligence-implemented processing (e.g., detection, classification, etc.) might be sent to the client device 602, among other such options. An encoder may be used to encode and/or compress at least some of this data before transmitting to the client device 602. In at least one embodiment, the client device 602 receiving such content can provide this content to a corresponding application 607 for selecting, providing, synthesizing, modifying, or using content for presentation (or other purposes) on or by the client device 602. A decoder may also be used to decode data received over the network(s) 614 for presentation via client device 602, such as image or video content through a touch-sensitive display 604. In at least one embodiment, at least some of the content may already be stored on, rendered on, or accessible to client device 602 such that transmission over network 614 is not required for at least that portion of content, such as where the content may have been previously downloaded or stored locally on a hard drive or optical disk. In at least one embodiment, a transmission mechanism such as data streaming can be used to transfer the content from server 620, or user database 636, to client device 602. In at least one embodiment, at least a portion of this content can be obtained, enhanced, and/or streamed from another source, such as a third party service 660 or other client device 603, that may also include a content application 662 for generating, enhancing, or providing content. In at least one embodiment, portions of this functionality can be performed using multiple computing devices, or multiple processors within one or more computing devices, such as may include a combination of CPUs and GPUs.

In at least one embodiment, the server 620 may include a processor such as a central processing unit (CPU). In at least one embodiment, however, resources in such environments can utilize GPUs to process data for at least certain types of requests. In at least one embodiment, with thousands of cores, GPUs are designed to handle substantial parallel workloads and, therefore, have become popular in deep learning for training neural networks and generating predictions. In at least one embodiment, while use of GPUs for offline builds has enabled faster training of larger and more complex models, generating predictions offline implies that either request-time input features cannot be used or predictions must be generated for all permutations of features and stored in a lookup table to serve real-time requests. In at least one embodiment, if a deep learning framework supports a CPU-mode and a model is small and simple enough to perform a feed-forward on a CPU with a reasonable latency, then a service on a CPU instance could host a model. In at least one embodiment, training can be done offline on a GPU and inference done in real-time on a CPU. In at least one embodiment, if a CPU approach is not a viable option, then a service can run on a GPU instance. In at least one embodiment, because GPUs have different performance and cost characteristics than CPUs, however, running a service that offloads a runtime algorithm to a GPU can require it to be designed differently from a CPU based service.

The server 620 may include a content application 624 that includes a content manager 626, rendering engine 630 and/or ray tracing module 632. As discussed previously, the content manager 626 may send objects, such as images and instructions, from the object repository 634 along with requests and other data from the client device 602 to a synthetic content generation system (implemented to include, for example and without limitation, rendering engine 630) for generating synthetic images. The synthetic content generation system 630 may generate synthetic images and provide the results to the transmission manager 622 for sending back to the client device 602. The synthetic defect generation system may also use local datasets or datasets provided by the third content service 660 for training machine learning models that can generate synthetic images and store the trained models to a model repository.

### Inference and Training Logic

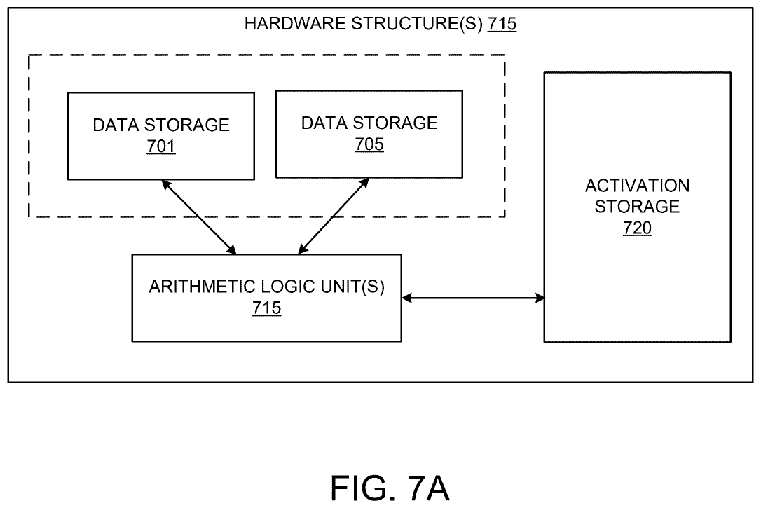

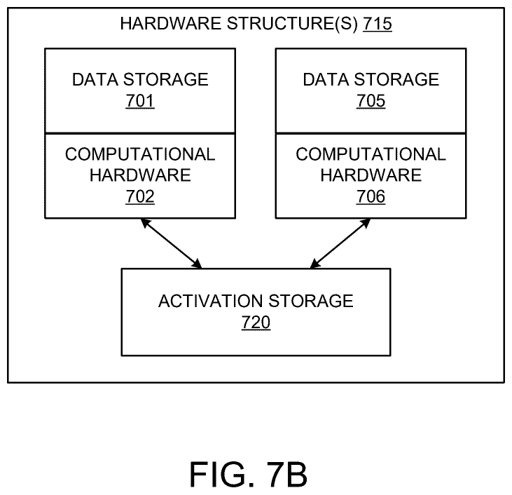

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 701 and/or code and/or data storage 705 are used as operands along with other values, such as bias values, gradient information, momentum values, or other parameters or hyperparameters, any or all of which may be stored in code and/or data storage 701 or code and/or data storage 705 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

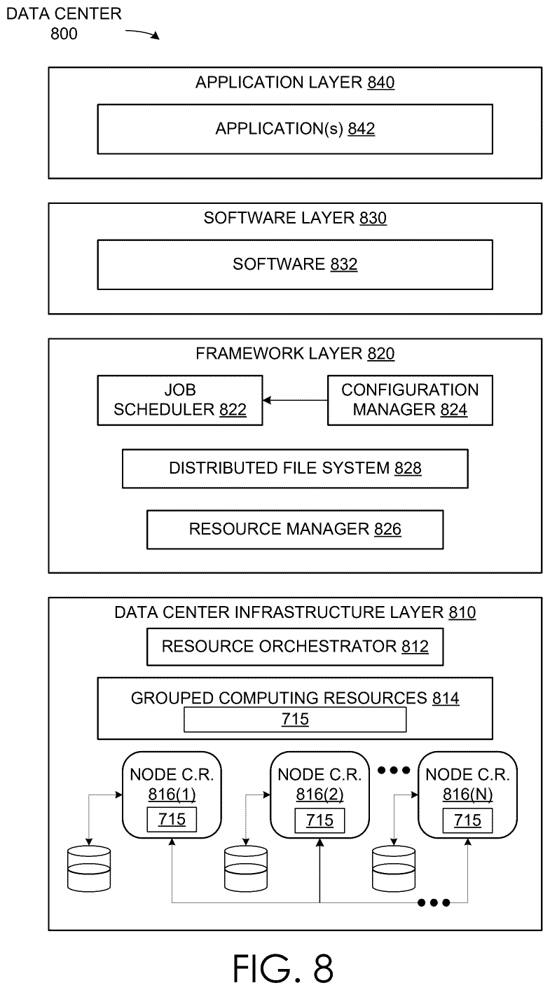

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to treat transparent sprites having similar material sprites and being part of a sprite group for which operations such as hit testing and reorientation can be performed inside a single hit shader without a need to call additional shaders.

### Computer Systems

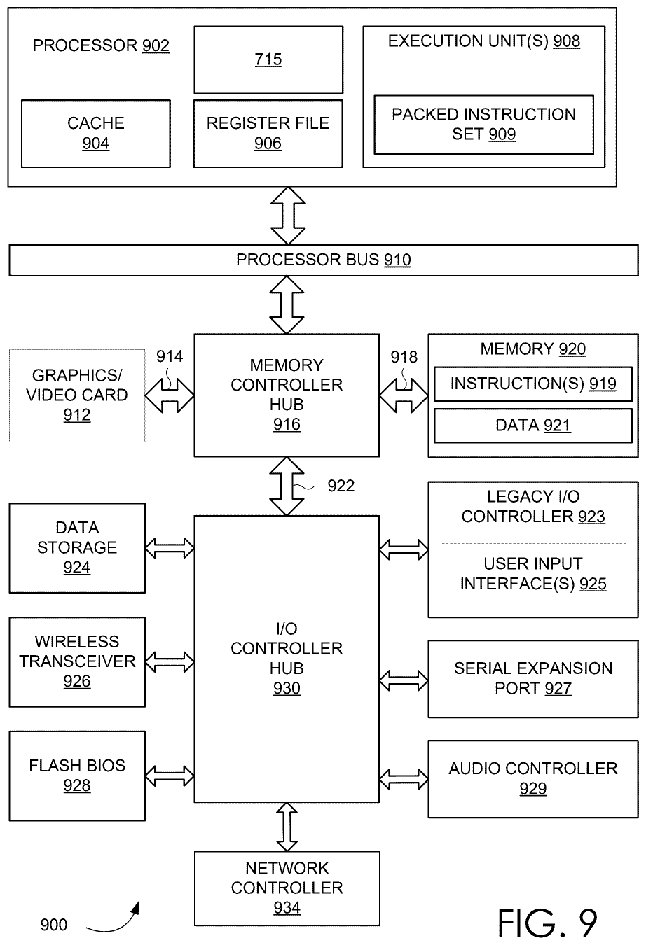

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®. XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution unit(s) 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word computing (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache 904 may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit(s) 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit(s) 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor data bus 910 for performing operations on packed data, which may eliminate need to transfer smaller units of data across processor data bus 910 to perform one or more operations one data element at a time.

In at least one embodiment, execution unit(s) 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interface(s) 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to treat transparent sprites having similar material sprites and being part of a sprite group for which operations such as hit testing and reorientation can be performed inside a single hit shader without a need to call additional shaders.

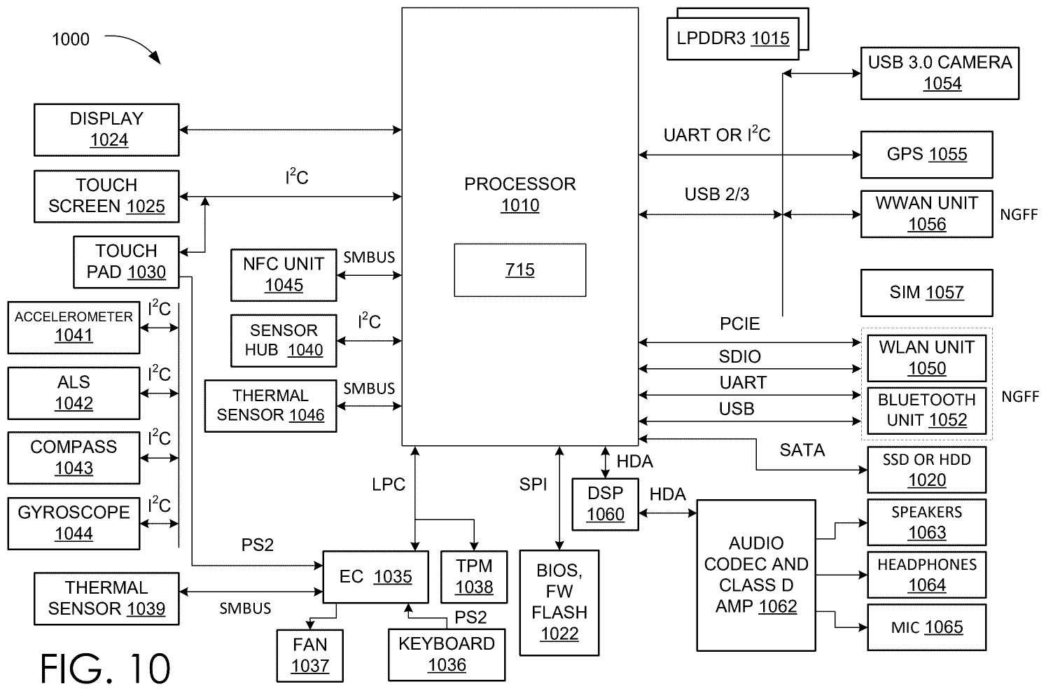

FIG. 10 is a block diagram illustrating an electronic device 1000 for using a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates an electronic device 1000, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to treat transparent sprites having similar material sprites and being part of a sprite group for which operations such as hit testing and reorientation can be performed inside a single hit shader without a need to call additional shaders.

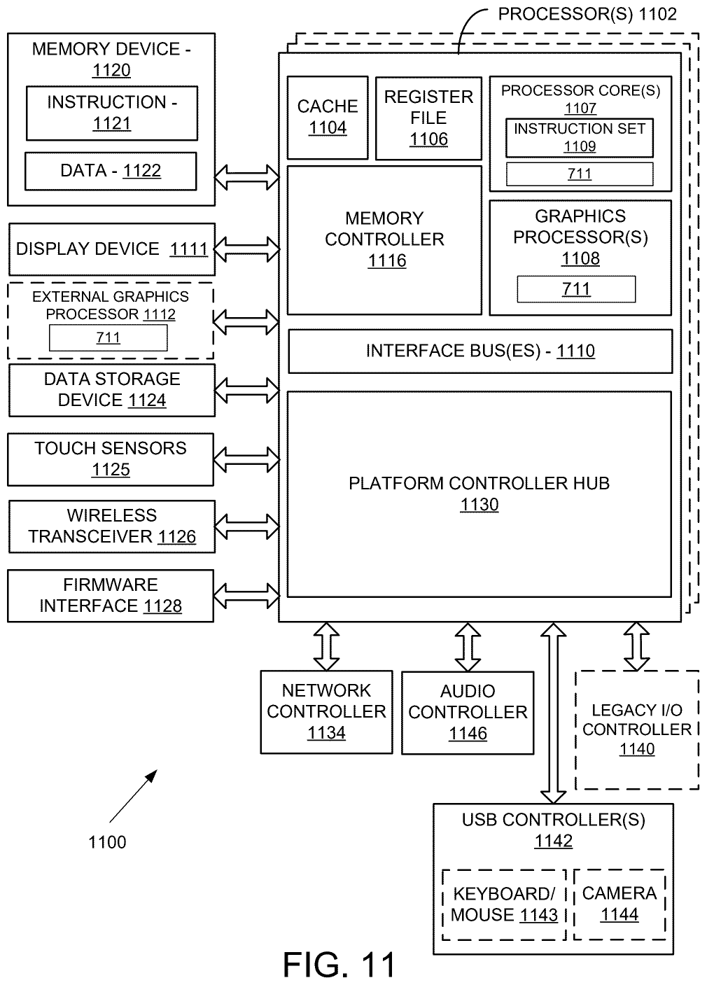

FIG. 11 is a block diagram of a processing system, according to at least one embodiment. In at least one embodiment, processing system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, processing system 1100 is a processing platform incorporated within a system-on-a-chip (SoC) integrated circuit for use in mobile, handheld, or embedded devices.

In at least one embodiment, processing system 1100 can include, or be incorporated within a server-based gaming platform, a game console, including a game and media console, a mobile gaming console, a handheld game console, or an online game console. In at least one embodiment, processing system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory (“cache”) 1104. In at least one embodiment, processor(s) 1102 can have a single internal cache or multiple levels of internal cache. In at least one embodiment, cache 1104 is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in processing system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory buses, or other types of interface buses. In at least one embodiment processor(s) 1102 include an integrated memory controller 1116 and a platform controller hub 1130. In at least one embodiment, memory controller 1116 facilitates communication between a memory device 1120 and other components of processing system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for processing system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 allows peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 allows communication with system firmware, and can be, for example, a unified extensible firmware interface (UEFI). In at least one embodiment, network controller 1134 can allow a network connection to a wired network. In at least one embodiment, a high-performance network controller (not shown) couples with interface bus(es) 1110. In at least one embodiment, audio controller 1146 is a multi-channel high definition audio controller. In at least one embodiment, processing system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, processing system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processing system 1100. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to treat transparent sprites having similar material sprites and being part of a sprite group for which operations such as hit testing and reorientation can be performed inside a single hit shader without a need to call additional shaders.

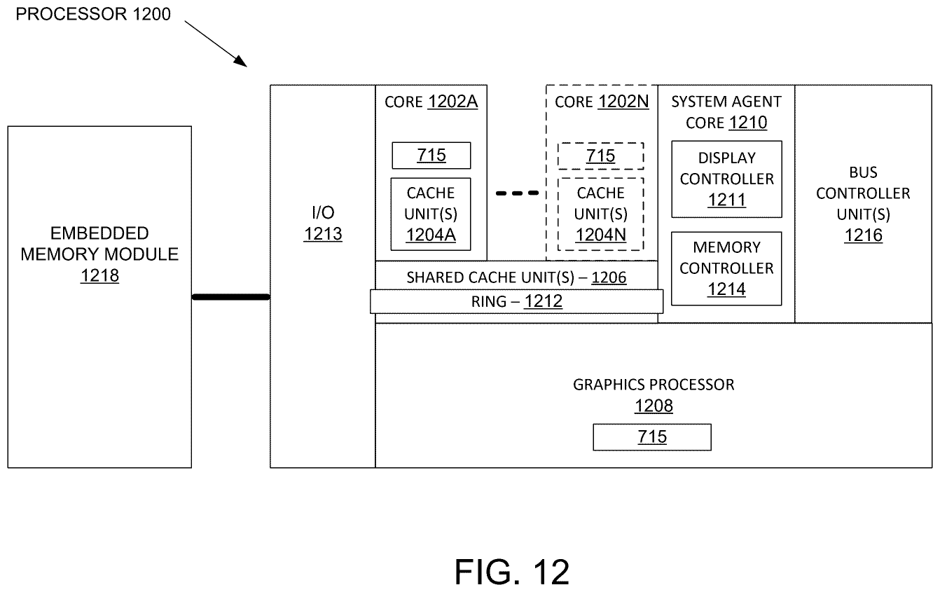

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core(s) 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache memory unit(s) 1204A-1204N may include at least one level of instruction and data cache within each processor core and one or more levels of shared mid-level cache, such as a Level 2 (L2), Level 3 (L3), Level 4 (LA), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express buses. In at least one embodiment, system agent core 1210 provides management functionality for various processor components. In at least one embodiment, system agent core 1210 includes one or more integrated memory controller(s) 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controller(s) 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory module 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to treat transparent sprites having similar material sprites and being part of a sprite group for which operations such as hit testing and reorientation can be performed inside a single hit shader without a need to call additional shaders.

### Virtualized Computing Platform

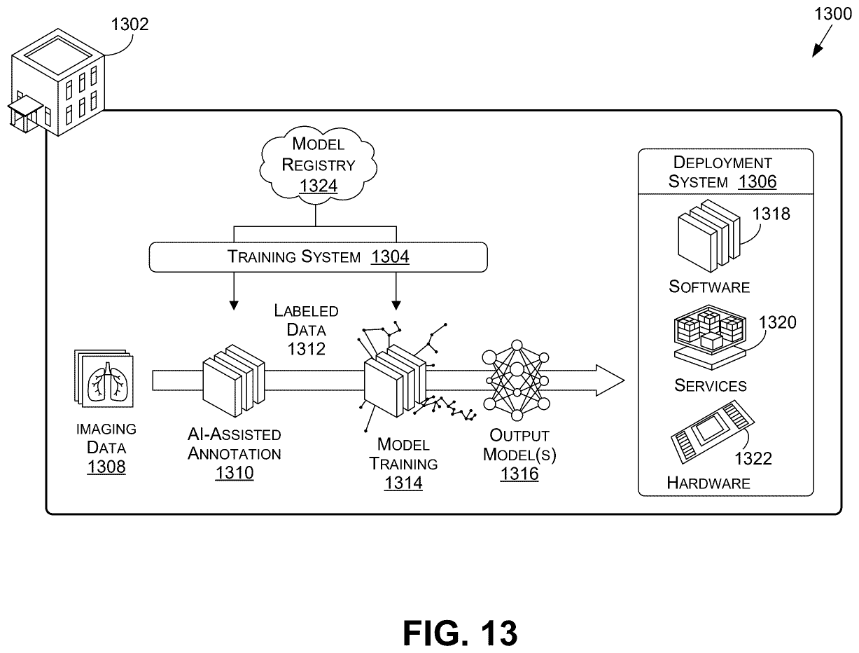

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facility(ies) 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility(ies) 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility(ies) 1302 using data 1308 (such as imaging data) generated at facility(ies) 1302 (and stored on one or more picture archiving and communication system (PACS) servers at facility(ies) 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1304 (FIG. 13) may include a scenario where facility(ies) 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, Al-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility(ies) 1302 needs a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility(ies) 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility(ies) 1302 requiring a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility(ies) 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility(ies) 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., processor 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.)

extraction and preparation of incoming data. In at least one embodiment, once validated by process 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., process 1300 of FIG. 13). In at least one embodiment, completed and validated applications or containers may be stored in a container registry and associated machine learning models may be stored in model registry 1324. In at least one embodiment, a requesting entity-who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform). In at least one embodiment, rather than each application that shares a same functionality offered by services 1320 being required to have a respective instance of services 1320, services 1320 may be shared between and among various applications. In at least one embodiment, services 1320 may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects-such as ray-tracing, rasterization, denoising, sharpening, etc.-to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a services 1320 includes an Al service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an Al/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility(ies) 1302), within an Al/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an Al/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to allow seamless scaling and load balancing.

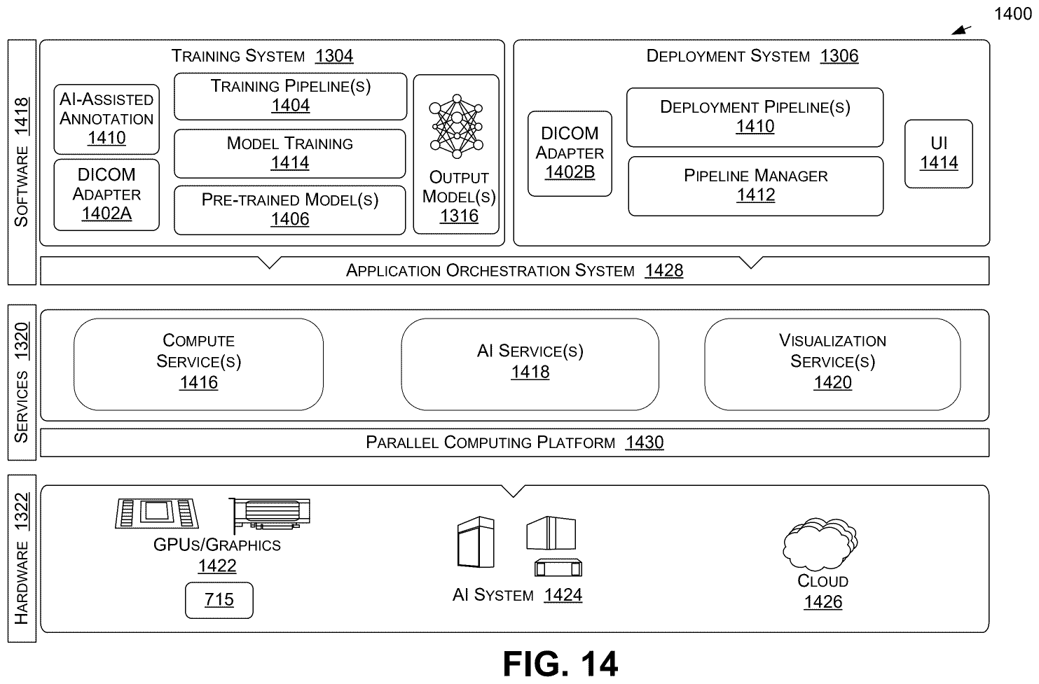

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipeline(s) 1404, similar to those described herein with respect to FIG. 13. In at least one embodiment, where one or more machine learning models are to be used in deployment pipeline(s) 1410 by deployment system 1306, training pipeline(s) 1404 may be used to train or retrain one or more (e.g. pre-trained) models, and/or implement one or more of pre-trained model(s) 1406 (e.g., without a need for retraining or updating). In at least one embodiment, as a result of training pipeline(s) 1404, output model(s) 1316 may be generated. In at least one embodiment, training pipeline(s) 1404 may include any number of processing steps, such as but not limited to imaging data (or other input data) conversion or adaption In at least one embodiment, for different machine learning models used by deployment system 1306, different training pipeline(s) 1404 may be used. In at least one embodiment, training pipeline(s) 1404 similar to a first example described with respect to FIG. 13 may be used for a first machine learning model, training pipeline(s) 1404 similar to a second example described with respect to FIG. 13 may be used for a second machine learning model, and training pipeline(s) 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipeline(s) 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation 1310 may be performed as part of deployment pipelines 1410; either in addition to, or in lieu of AI-assisted annotation 1310 included in training pipeline(s) 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility(ies) 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may allow general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to allow seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

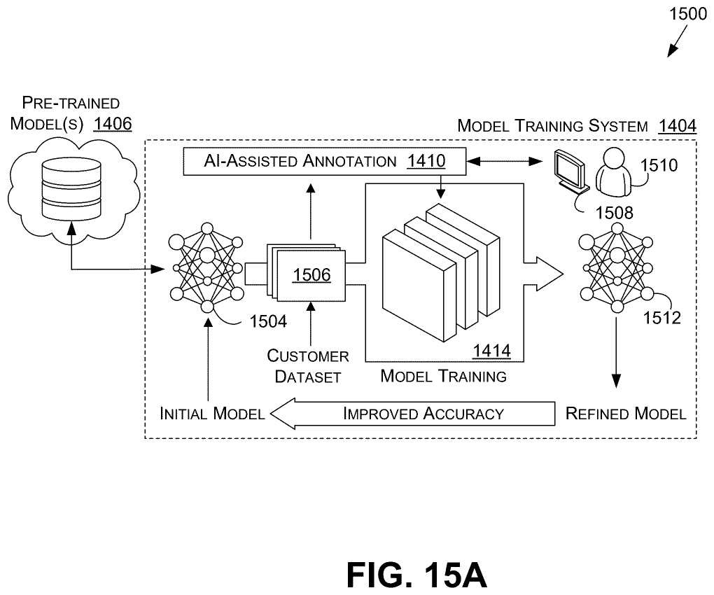

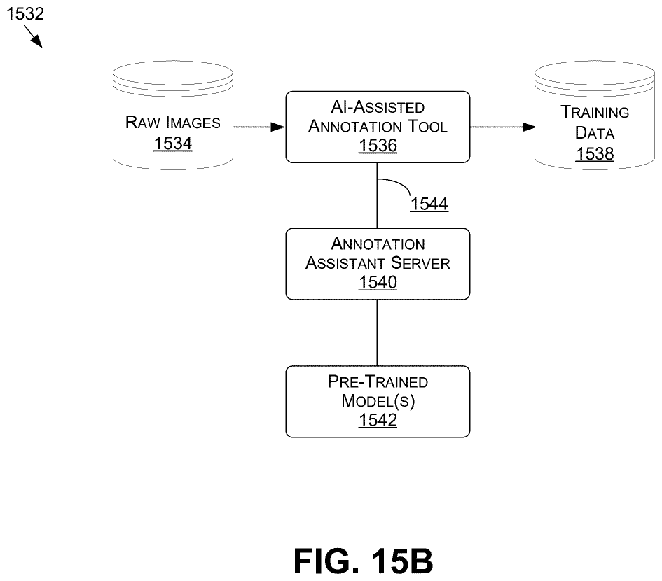

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined model 1512 generated by process 1500 may be executed by a deployment system for one or more containerized applications in deployment pipelines 1510.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained model(s) 1506 may be stored in a data store, or registry. In at least one embodiment, pre-trained model(s) 1506 may have been trained, at least in part, at one or more facilities other than a facility executing process 1500. In at least one embodiment, to protect privacy and rights of patients, subjects, or clients of different facilities, pre-trained model(s) 1506 may have been trained, on-premise, using customer or patient data generated on-premise. In at least one embodiment, pre-trained model(s) 1506 may be trained using a cloud and/or other hardware, but confidential, privacy protected patient data may not be transferred to, used by, or accessible to any components of a cloud (or other off premise hardware). In at least one embodiment, where pre-trained model(s) 1506 is trained at using patient data from more than one facility, pre-trained model(s) 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model(s) 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select pre-trained model(s) 1506 to use with an application. In at least one embodiment, pre-trained model(s) 1506 may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model(s) 1506 may be updated, retrained, and/or fine-tuned for use at a respective facility.

In at least one embodiment, a user may select pre-trained model(s) 1506 that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by model training system 1304. In at least one embodiment, ground truth data may be generated, at least in part, by clinicians, scientists, doctors, practitioners, at a facility.

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from Al-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation model(s) 1542, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an annotation assistant server 1540 that may include a set of pre-trained model(s) 1542 stored in an annotation model registry, for example. In at least one embodiment, an annotation model registry may store pre-trained model(s) 1542 (e.g., machine learning models, such as deep learning models) that are pre-trained to perform AI-assisted annotation 1310 on a particular organ or abnormality. These models may be further updated by using training pipelines. In at least one embodiment, pre-installed annotation tools may be improved over time as new labeled data is added.

Various embodiments can be described by the following clauses:
1. A computer-implemented method, comprising:
simulating a path of a ray through a scene for which an image is to be rendered, the scene including a group of translucent sprites having similar material property values;
determining, using a shader and in response to the ray intersecting a bounding volume surrounding the group of translucent sprites, a color value for a pixel location of the image that is associated with the ray;
performing, using the shader, a reorientation of one or more of the translucent sprites from the group of translucent sprites based in part on at least the direction of the ray or an orientation of a main camera for the scene;
determining, using the shader, locations of translucent sprites that intersect the ray; and
determining, using the shader, the color value to return for the pixel location based in part upon the locations of the translucent sprites that intersect the ray, and the similar material property values of the translucent sprites.
2. The computer-implemented method of clause 1, further comprising:
determining, using a second shader and in response to the ray intersecting a second bounding volume surrounding a second group of translucent sprites having second material properties, a second color value for the pixel location of the image that is associated with the ray;
performing, using the second shader, a reorientation of one or more translucent sprites of the second group;
determining, using the second shader, locations of translucent sprites of the second group that intersect the ray; and
determining, using the second shader, the second color value to return for the pixel location based in part upon the locations of the translucent sprites of the second group that intersect the ray, and the second material properties.
3. The computer-implemented method of clause 1, further comprising:
generating, for one or more of the translucent sprites that are intersected by a secondary ray corresponding to at least one of a reflection, a refraction, or a diffraction of the ray, an instance of the one or more translucent sprites in a virtual space based in part upon an apparent position of the one or more translucent sprites.
4. The computer-implemented method of clause 3, further comprising:
determining the apparent position of the one or more translucent sprites based in part on at least one of the reflection, the refraction, or the diffraction of the ray, and upon a position of a main camera used to determine a view of the scene to be represented in the image to be rendered; and
reorienting the one or more translucent sprites based in part upon the apparent position with respect to an orientation of the main camera.
5. The computer-implemented method of clause 1, wherein the translucent sprites are two-dimensional (2D) images representing individual particles in the particle simulation.
6. The computer-implemented method of clause 1, wherein the locations of reoriented sprites that intersect the ray are determined in the shader without separate calls to one or more shaders for individual sprites of the group.
7. A processor comprising one or more circuits to:
simulate a path of a ray through a group of translucent particles having at least one material property value;
determine, using a shader and in response to the ray intersecting a bounding box surrounding the group of translucent particles, locations of one or more of the translucent particles in the group that are intersected by the ray; and
determine, using the shader, a color value based in part upon the locations of the translucent particles that are intersected by the ray, and the at least one material property value.
8. The processor of clause 7, wherein the translucent particles correspond to at least one of one or more sprites, one or more quads, one or more ribbons, or one or more meshes used to represent an appearance of the translucent particles.
9. The processor of clause 7, wherein the one or more circuits are further to:
generate, for one or more of the translucent sprites that are intersected by a secondary ray corresponding to at least one of a reflection, a refraction, or a diffraction of the ray, an instance of the one or more translucent sprites in a virtual space based in part upon an apparent position of the one or more translucent sprites.
10. The processor of clause 9, wherein the one or more circuits are further to:
determine the apparent position of the one or more translucent sprites based in part on the at least one of the reflection, the refraction, or the diffraction, and a position of a main camera used to determine a view of the scene to be represented in the image to be rendered; and
reorient the one or more translucent sprites based in part upon the apparent position with respect to an orientation of the main camera.
11. The processor of clause 7, wherein the one or more circuits are further to:
determine, using a second shader and in response to the ray intersecting a second bounding box surrounding a second group of translucent sprites having second material properties, a second color value for the pixel location of the image that is associated with the ray;
perform, using the second shader, a reorientation of one or more of the second group of translucent sprites;
determine, using the second shader, locations of the translucent sprites of the second group that intersect the ray; and
determine, using the second shader, the second color value to return for the pixel location based in part upon the locations of the translucent sprites of the second group that intersect the ray, and the second material properties.
12. The processor of clause 7, wherein the translucent sprites are two-dimensional (2D) images representing individual particles in the particle simulation.
13. The processor of clause 7, wherein the locations of reoriented sprites that intersect the ray are determined in the shader without separate calls to one or more shaders for individual sprites of the group.
14. The processor of clause 7, wherein the processor is included in a system comprising at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system for performing generative AI operations using a vision-language model (VLM);
a collaborative content creation platform for 3D assets; or
a system implemented at least partially using cloud computing resources.
15. A system comprising:
one or more processors to determine a color value for a pixel location of an image to be rendered by, in part, simulating a path of a ray through a group of translucent particles, having similar material properties, and determining an intersection of the ray with a boundary surrounding the group of particles, the one or more processors further to invoke a shader, for the group of particles, to determine the color value based in part upon locations of individual particles that are intersected by the ray and have the similar material properties.
16. The system of clause 15, wherein the one or more processors are further to:
generate, for one or more of the translucent sprites that are intersected by a secondary ray corresponding to at least one of a reflection, a refraction, or a diffraction of the ray, an instance of the one or more translucent sprites in a virtual space based in part upon an apparent position of the one or more translucent sprites.
17. The system of clause 16, wherein the one or more processors are further to:
determine the apparent position of the one or more translucent sprites based in part on the at least one of the reflection, the refraction, or the diffraction, and a position of a main camera used to determine a view of the scene to be represented in the image to be rendered; and
reorient the one or more translucent sprites based in part upon the apparent position with respect to an orientation of the main camera.
18. The system of clause 15, wherein the one or more processors are further to:
invoke, in response to the ray intersecting a second boundary surrounding a second group of translucent sprites having second material properties, a second shader to determine a second color value for the pixel location of the image that is associated with the ray;
perform, using the second shader, a reorientation of one or more of the second group of translucent sprites;
determine, using the second shader, locations of the translucent sprites of the second group that intersect the ray; and
determine, using the second shader, the second color value to return for the pixel location based in part upon the locations of the translucent sprites of the second group, which intersect the ray, and the second material properties.
19. The system of clause 15, wherein the locations of translucent sprites that intersect the ray are determined in the shader without separate calls to one or more shaders for individual sprites of the group.
20. The system of clause 15, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system for performing generative AI operations using a vision-language model (VLM);
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
simulating a path of a ray through a scene for which an image is to be rendered, the scene including a group of translucent sprites having similar material property values;
determining, using a shader and in response to the ray intersecting a bounding volume surrounding the group of translucent sprites, a color value for a pixel location of the image that is associated with the ray;
performing, using the shader, a reorientation of one or more of the translucent sprites from the group of translucent sprites based in part on at least the direction of the ray or an orientation of a main camera for the scene;
determining, using the shader, locations of translucent sprites that intersect the ray; and
determining, using the shader, the color value to return for the pixel location based in part upon the locations of the translucent sprites that intersect the ray, and the similar material property values of the translucent sprites.

2. The computer-implemented method of claim 1, further comprising:
determining, using a second shader and in response to the ray intersecting a second bounding volume surrounding a second group of translucent sprites having second material properties, a second color value for the pixel location of the image that is associated with the ray;
performing, using the second shader, a reorientation of one or more translucent sprites of the second group;
determining, using the second shader, locations of translucent sprites of the second group that intersect the ray; and
determining, using the second shader, the second color value to return for the pixel location based in part upon the locations of the translucent sprites of the second group that intersect the ray, and the second material properties.

3. The computer-implemented method of claim 1, further comprising:
generating, for one or more of the translucent sprites that are intersected by a secondary ray corresponding to at least one of a reflection, a refraction, or a diffraction of the ray, an instance of the one or more translucent sprites in a virtual space based in part upon an apparent position of the one or more translucent sprites.

4. The computer-implemented method of claim 3, further comprising:
determining the apparent position of the one or more translucent sprites based in part on at least one of the reflection, the refraction, or the diffraction of the ray, and upon a position of a main camera used to determine a view of the scene to be represented in the image to be rendered; and
reorienting the one or more translucent sprites based in part upon the apparent position with respect to an orientation of the main camera.

5. The computer-implemented method of claim 1, wherein the translucent sprites are two-dimensional (2D) images representing individual particles in the particle simulation.

6. The computer-implemented method of claim 1, wherein the locations of reoriented sprites that intersect the ray are determined in the shader without separate calls to one or more shaders for individual sprites of the group.

7. A processor comprising one or more circuits to:
simulate a path of a ray through a group of translucent particles having at least one material property value;
determine, using a shader and in response to the ray intersecting a bounding box surrounding the group of translucent particles, locations of one or more of the translucent particles in the group that are intersected by the ray; and
determine, using the shader, a color value based in part upon the locations of the translucent particles that are intersected by the ray, and the at least one material property value.

8. The processor of claim 7, wherein the translucent particles correspond to at least one of one or more sprites, one or more quads, one or more ribbons, or one or more meshes used to represent an appearance of the translucent particles.

9. The processor of claim 7, wherein the one or more circuits are further to:
generate, for one or more of the translucent sprites that are intersected by a secondary ray corresponding to at least one of a reflection, a refraction, or a diffraction of the ray, an instance of the one or more translucent sprites in a virtual space based in part upon an apparent position of the one or more translucent sprites.

10. The processor of claim 9, wherein the one or more circuits are further to:
determine the apparent position of the one or more translucent sprites based in part on the at least one of the reflection, the refraction, or the diffraction, and a position of a main camera used to determine a view of the scene to be represented in the image to be rendered; and
reorient the one or more translucent sprites based in part upon the apparent position with respect to an orientation of the main camera.

11. The processor of claim 7, wherein the one or more circuits are further to:
determine, using a second shader and in response to the ray intersecting a second bounding box surrounding a second group of translucent sprites having second material properties, a second color value for the pixel location of the image that is associated with the ray;
perform, using the second shader, a reorientation of one or more of the second group of translucent sprites;
determine, using the second shader, locations of the translucent sprites of the second group that intersect the ray; and
determine, using the second shader, the second color value to return for the pixel location based in part upon the locations of the translucent sprites of the second group that intersect the ray, and the second material properties.

12. The processor of claim 7, wherein the translucent sprites are two-dimensional (2D) images representing individual particles in the particle simulation.

13. The processor of claim 7, wherein the locations of reoriented sprites that intersect the ray are determined in the shader without separate calls to one or more shaders for individual sprites of the group.

14. The processor of claim 7, wherein the processor is included in a system comprising at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system for performing generative AI operations using a vision-language model (VLM);
a collaborative content creation platform for 3D assets; or
a system implemented at least partially using cloud computing resources.

15. A system comprising:
one or more processors to determine a color value for a pixel location of an image to be rendered by, in part, simulating a path of a ray through a group of translucent particles, having similar material properties, and determining an intersection of the ray with a boundary surrounding the group of particles, the one or more processors further to invoke a shader, for the group of particles, to determine the color value based in part upon locations of individual particles that are intersected by the ray and have the similar material properties.

16. The system of claim 15, wherein the one or more processors are further to:
generate, for one or more of the translucent sprites that are intersected by a secondary ray corresponding to at least one of a reflection, a refraction, or a diffraction of the ray, an instance of the one or more translucent sprites in a virtual space based in part upon an apparent position of the one or more translucent sprites.

17. The system of claim 16, wherein the one or more processors are further to:
determine the apparent position of the one or more translucent sprites based in part on the at least one of the reflection, the refraction, or the diffraction, and a position of a main camera used to determine a view of the scene to be represented in the image to be rendered; and
reorient the one or more translucent sprites based in part upon the apparent position with respect to an orientation of the main camera.

18. The system of claim 15, wherein the one or more processors are further to:
invoke, in response to the ray intersecting a second boundary surrounding a second group of translucent sprites having second material properties, a second shader to determine a second color value for the pixel location of the image that is associated with the ray;
perform, using the second shader, a reorientation of one or more of the second group of translucent sprites;
determine, using the second shader, locations of the translucent sprites of the second group that intersect the ray; and
determine, using the second shader, the second color value to return for the pixel location based in part upon the locations of the translucent sprites of the second group, which intersect the ray, and the second material properties.

19. The system of claim 15, wherein the locations of translucent sprites that intersect the ray are determined in the shader without separate calls to one or more shaders for individual sprites of the group.

20. The system of claim 15, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center,
a system for performing hardware testing using simulation;
a system for synthetic data generation;
a system for performing generative AI operations using a large language model (LLM);
a system for performing generative AI operations using a vision-language model (VLM);
a collaborative content creation platform for 3D assets; or
a system implemented at least partially using cloud computing resources.
